(19) United States
(12) Patent Application Publication
(10) Pub. No.: US 2006/0191894 A1
(43) Pub. Date: Aug. 31, 2006

(54) Electronic appliance using heat radiation plate

(75) Inventors: Ryosuke Usui, Ichinomiya-City (JP); Hideki Mizuhara, Ichinomiya-City (JP); Yasunori Inoue, Ogaki-City (JP); Noriaki Kojima, Ogaki-City (JP); Hiroyuki Watanabe, Ichinomiya-City (JP); Shinya Nakano, Anpachi-Gun (JP)

Correspondence Address: MCDERMOTT WILL & EMERY LLP, 600 13TH STREET, N.W., WASHINGTON, DC, 20005-3096, US

(73) Assignee: SANYO ELECTRIC CO., LTD.

(21) Appl. No.: 11/362,121

(22) Filed: Feb. 27, 2006

(30) Foreign Application Priority Data
Feb. 28, 2005 (JP) 2005-054220
Feb. 28, 2005 (JP) 2005-054221
Feb. 16, 2006 (JP) 2006-039993

(51) Int. Cl. H05B 3/68

(52) U.S. Cl. 219/466.1

(57) ABSTRACT

In a heat radiation structure for an electronic appliance in which heat generated in a heat generating member inside a flap of the electronic appliance is radiated to a space outside the flap, a heat radiation plate integrally formed with a circuit element is thermally coupled to the heat generating member and is exposed outside the flap. Heat generated in the heat generating member is conducted to the heat radiation plate via a contact portion and is radiated to a space outside the flap from an exposed surface along with heat generated in the circuit element.

### BACKGROUND OF THE INVENTION

1. Field of the Invention

The present invention generally relates to a heat radiation technology and, more particularly, to a heat radiation technology for an electronic appliance.

2. Description of the Related Art

In recent years, electronic appliances such as cell phones have become more and more sophisticated in their performance and function. In association with this, power consumed by electronic components used inside the appliances tends to increase. Particularly, high-performance LSIs for advanced image processing consume large power, and the amount of heat generated by a battery unit that supplies electric power to such electronic components is also large.

Related-art measures for heat radiation include a heat radiation structure using a metallic heat sink or fan. Meanwhile, electronic appliances such as cell phones must meet stringent requirements for miniaturization and so space constraints make it difficult to provide a satisfactory heat radiation structure.

Patent document 1 proposes a heat radiation structure for a mobile communication terminal in which it is difficult to provide a cooling device. In this heat radiation structure, a heat radiation unit is provided on the surface of electronic components mounted inside a flap of the communication terminal so as to extend outside the flap.

[Patent Document No. 1]

JP 2001-230578 A

However, there is a need to consider radiant heat in the heat radiation structure of patent document No. 1 and so constraints are placed on component layout. Moreover, since an extension is provided to connect electronic components and the heat radiation unit, there are limitations to the miniaturization of the flap. Another problem with the related-art structure is that radiant heat from the extension causes back flow of heat into the flap, thereby impairing heat radiation efficiency.

### SUMMARY OF THE INVENTION

In at least one embodiment of the present invention, a heat radiation structure for an electronic appliance, which radiates heat generated in a heat generating member inside a flap to a space outside the flap, comprises: a heat radiation plate integrally formed with a circuit element, wherein the heat radiation plate is thermally coupled to the heat generating member and is provided at a position exposed outside the flap.

According to this embodiment, heat generated in the heat generating member is conducted to the heat radiation plate and is radiated by the heat radiation plate to a space outside the flap along with heat generated in the circuit element. Since there is no need to provide an additional heat radiation plate for the heat generating member, the cost and size of the electronic appliance are effectively reduced.

In at least one embodiment of the present invention, a mobile appliance, in which a first flap and a second flap are connected to each other via a movable part, and which assumes at least two states including a first state in which the first flap and the second flap are open and a second state in which the flaps are closed, comprises: a heat radiation plate exposed outside the first flap, wherein an exposed surface of the heat radiation plate is covered by the second flap in the second state.

According to this embodiment, heat generated in the first flap is conducted to the heat radiation plate and radiated from the exposed surface of the heat radiation plate. Since the exposed surface of the heat radiation plate is exposed outside the first flap, heat is prevented from being contained inside the first flap and is radiated outside the first flap efficiently.

In a state in which the mobile appliance is closed, the exposed surface of the heat radiation plate is covered by the second flap and is not brought into contact with a user's body. Even if the circuit element is driven while the mobile appliance is being placed in a pocket of the clothes, there is no worry that low-temperature burn is caused.

It is to be noted that any arbitrary combination or rearrangement of the above-described structural components and so forth are all effective as and encompassed by the present embodiments.

Moreover, this summary of the invention does not necessarily describe all necessary features so that the invention may also be sub-combination of these described features.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a sectional view showing the heat radiation structure of an electronic appliance according to a first embodiment of the present invention;

FIG. 2 is a sectional view showing the structure of a circuit device according to the first embodiment;

FIG. 3 shows how heat is radiated by the heat radiation structure according to the first embodiment;

FIG. 4 is a sectional view showing the structure of the circuit device according to a variation of the first embodiment;

FIG. 5 shows the structure of a mobile appliance according to a second embodiment of the present invention;

FIG. 6 is a sectional view showing the mobile appliance according to the second embodiment in an opened state;

FIG. 7 is a sectional view showing the structure of a circuit device according to the second embodiment;

FIG. 8 shows how heat is radiated in the circuit device according to the second embodiment;

FIG. 9 is a sectional view showing the mobile appliance according to the second embodiment in a closed state;

FIG. 10 is a sectional view showing the circuit device according to a variation of the second embodiment;

FIG. 11 shows the structure of a mobile appliance according to a third embodiment of the present invention;

FIG. 12 is a sectional view showing the mobile appliance according to the third embodiment in a closed state;

FIG. 13 is a sectional view showing the mobile appliance according to a fourth embodiment of the present invention;

FIG. 14 is a sectional view showing a mobile appliance according to a fifth embodiment of the present invention;

FIG. 15 is a sectional view showing a mobile appliance according to a sixth embodiment of the present invention; and

FIG. 16 shows a mobile appliance according to a seventh embodiment of the present invention.

### DETAILED DESCRIPTION OF THE INVENTION

A detailed description of the embodiments of the present invention will be given below with reference to the drawings.

### First Embodiment

A primary purpose of the first embodiment is to provide a heat radiation structure for an electronic appliance, for radiating heat generated in a heat-generating member inside a flap to a space outside the flap.

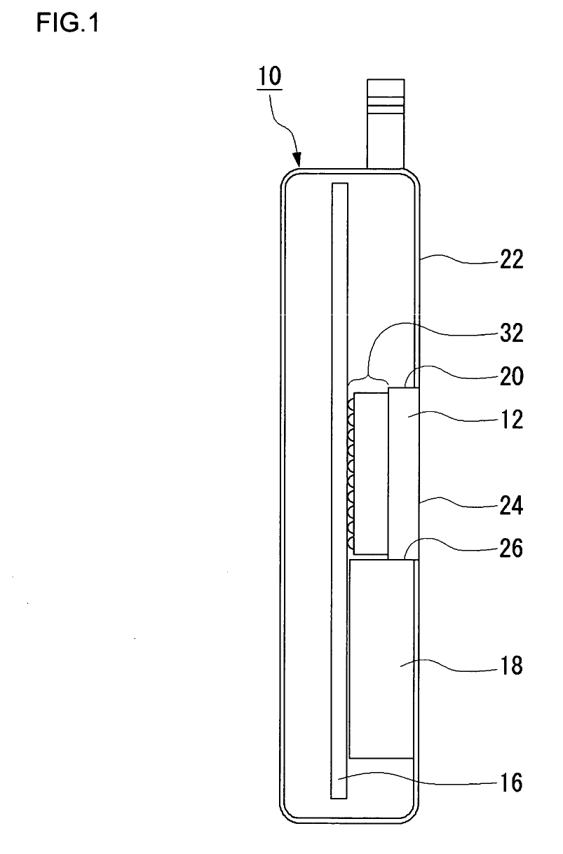

FIG. 1 is a sectional view showing the heat radiation structure of an electronic appliance according to the first embodiment of the present invention. As shown in FIG. 1, inside a flap 22 of an electronic appliance 10 are provided: a printed board 16; a circuit device 20 integrally including a heat radiation plate 12 and a circuit unit 32; and a heat generating member 18. The circuit device 20 is electrically connected with the printed board 16 via a solder provided on a surface opposite to the heat radiation plate 12.

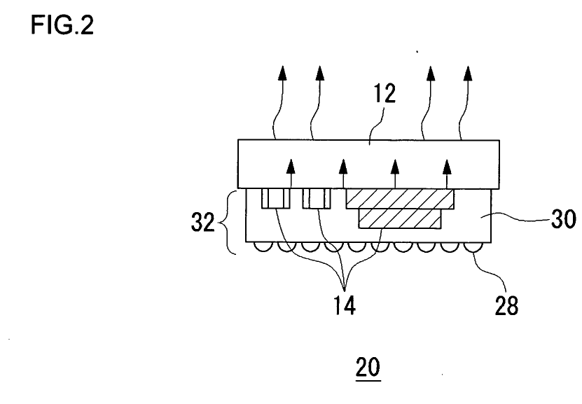

FIG. 2 is a sectional view showing the structure of the circuit device according to the first embodiment. In FIG. 2, arrows indicate the flow of heat. The circuit device 20 integrally comprises the heat radiation plate 12 and the circuit unit 32 formed thereon. The circuit unit 32 is provided with circuit elements 14, an insulating layer 30 covering the circuit elements 14, and solders 28. The circuit elements 14 include active elements and passive elements. The insulating layer 30 is provided with conductive regions electrically connecting between the circuit elements 14 and between the circuit element 14 and the solder 28. The heat radiation plate 12 may be made by a metal with excellent thermal conductivity such as copper and aluminum.

As shown in FIG. 2, heat generated in the circuit elements 14 integrally formed with the heat radiation plate 12 is radiated by being conducted to the heat radiation plate 12. Accordingly, an increase in the temperature of the circuit elements 14 is suppressed.

As shown in FIG. 1, the surface of the heat radiation plate 12 of the circuit device 20 that is opposite to the surface on which the circuit unit 32 is formed is exposed outside the flap 22. Hereinafter, the surface exposed outside the flap 22 will be referred to as an exposed surface 24. The exposed surface 24 of the heat radiation plate 12 may be polished to obscure the boundary with the flap 22. Alternatively, surface treatment such as coating may be applied to the exposed surface 24 of the heat radiation plate 12 to obscure the boundary with the flap 22. For example, the surface treatment may be the spray coating of the exposed surface 24 of the heat radiation plate 12 with acrylic resin with a coating thickness of approximately 2-15 μm.

The heat generating member 18 and the heat radiation plate 12 are thermally coupled to each other by being partially in contact with each other. The term “thermally coupled” designates a state in which thermal conduction is enabled between the heat generating member 18 and the heat radiation plate 12. It is preferable that as large an area of contact as possible be provided to enhance thermal conduction efficiency. The heat generating member 18 and the heat radiation plate 12 are fixed using a metal fitting to prevent a gap from being created in a contact portion 26 due to shock such as vibration. Alternatively, the heat generating member 18 and the heat radiation plate 12 are fixed by pressing them by the flap 22.

Resin or adhesive, which are characterized by excellent thermal conductivity, may be sandwiched between the heat radiation plate 12 and the heat generating member 18. In this case, the possibility of a gap being created in the contact portion 26 due to shock such as vibration is reduced, while also maintaining thermal conduction efficiency. Also, pressure caused by pressing the metal fitting is mitigated.

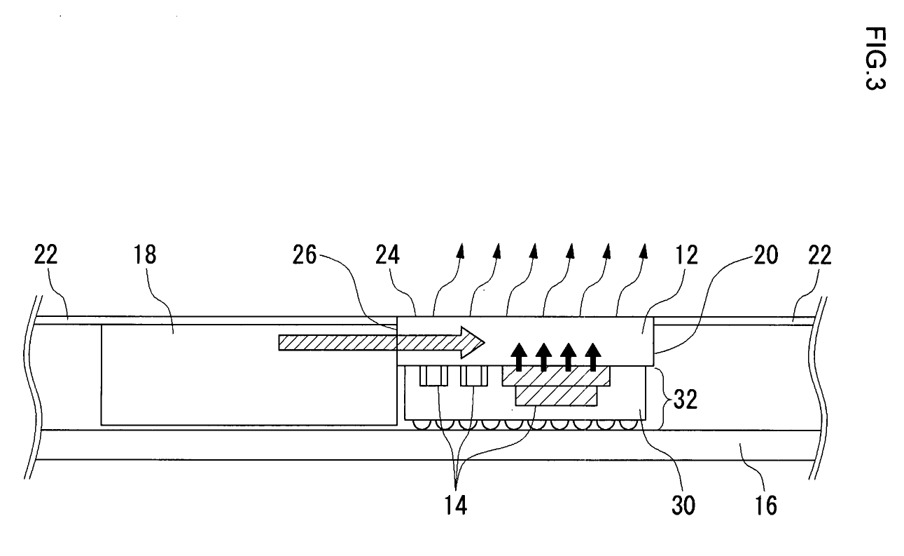

FIG. 3 shows how heat is radiated by the heat radiation structure according to the first embodiment. In FIG. 3, arrows designate the flow of heat. As shown in FIG. 3, heat generated in the heat generating member 18 is conducted to the heat radiation plate 12 thermally coupled to the heat generating member 18. If resin or adhesive, which are characterized by excellent thermal conductivity, are sandwiched between the heat radiation plate 12 and the heat generating member 18, heat is conducted via the resin or adhesive.

Heat conducted from the heat generating member 18 to the heat radiation plate 12 and heat generated in the circuit elements 14 are radiated by the heat radiation plate 12 to a space outside the flap 22. Since the exposed surface 24 of the heat radiation plate 12 is exposed outside the flap 22, heat is prevented from being contained inside the flap 22 and is radiated outside the flap 22 efficiently.

As heat is radiated as described above, an increase in temperature around the heat generating member 18 is suppressed. This allows high-density mounting of electronic components by enabling electronic components to be arranged in the neighborhood of the heat generating member 18. Direct thermal coupling between the heat generating member 18 and the heat radiation plate 12 improves heat radiation efficiency and is effective for miniaturization of the electronic appliance 10. Further, since there is no need to provide an additional heat radiation plate for the heat generating member 18, the cost and size of the electronic appliance 10 are effectively reduced.

When the heat radiation mechanism according to the embodiment is applied to the large-scale circuit unit 32 in which a large number of functions are integrated, heat radiation efficiency is significantly improved due to the effect of the heat radiation plate 12 having substantially the same area as the mounting area of the circuit unit 32.

The heat generating member 18 may be a battery unit. A battery unit occupies a large area in the flap of a small-sized electronic appliance such as a cell phone. Therefore, an area for mounting electronic components is significantly increased by employing the heat radiation structure according to the embodiment.

If the heat radiation structure according to the embodiment is applied to a battery unit, the service life of the battery is extended so that prolonged operation of the electronic appliance is possible. The heat generating member 18 may be a circuit element such as a speaker amplifier characterized by large amount of generated heat or a circuit unit for driving a liquid crystal.

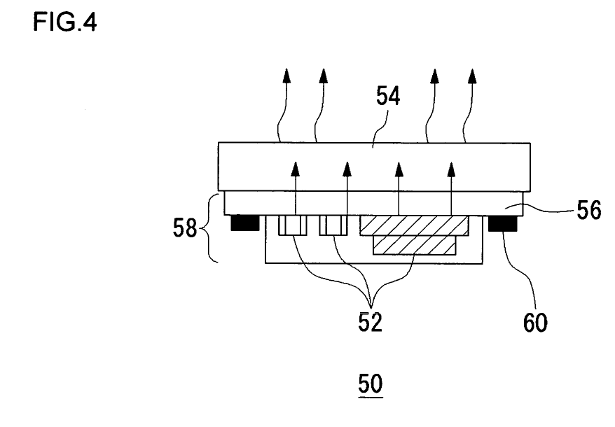

FIG. 4 is a sectional view showing the structure of the circuit device according to a variation of the first embodiment. In FIG. 4, arrows designate the flow of heat. A circuit device 50 integrally comprises a heat radiation plate 54 and a circuit unit 58 formed thereon. The circuit unit 58 is provided with an insulating layer 56, circuit elements 52 and an electrode 60. The circuit elements 52 include active elements and passive elements. The insulating layer 56 is provided with conductive regions electrically connecting between the circuit elements 52 and between the circuit element 52 and the electrode 60.

A material in which heat conductive filler is used as an additive may be used to form the insulating layer 56 in order to increase the heat radiation efficiency of the circuit elements 52. The heat radiation plate 54 may be made by a metal with excellent thermal conductivity such as copper and aluminum. The circuit device 50 is electrically connected to a printed board via the electrode 60.

As shown in FIG. 4, heat generated in the circuit elements 52 is radiated by being conducted to the heat radiation plate 54 via the insulating layer 56. Accordingly, an increase in the temperature of the circuit elements 52 is suppressed. Even when the circuit device 20 of the electronic appliance 10 shown in FIG. 1 is replaced by the circuit device 50 shown in FIG. 4, heat conducted from the heat generating member 18 to the heat radiation plate 54 and heat generated in the circuit elements 52 are efficiently radiated to a space outside the flap 22.

### Second Embodiment

A primary purpose of the second embodiment is to provide a mobile appliance in which heat inside the flap is efficiently radiated to a space outside the flap.

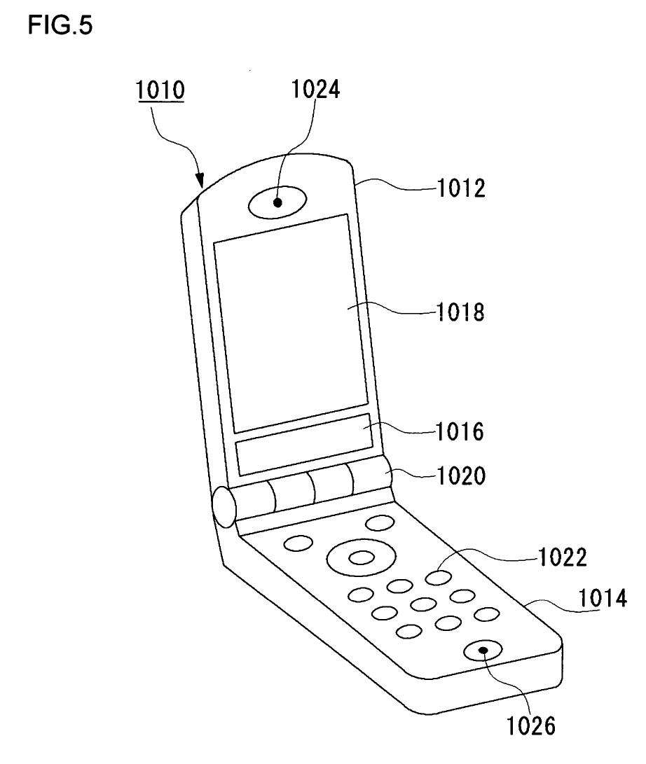

FIG. 5 shows the structure of a mobile appliance according to the second embodiment of the present invention. As shown in FIG. 5, a mobile appliance 1010 is formed such that a first flap 1012 and a second flap 1014 are connected to each other by a movable part 1020. The first flap 1012 and the second flap 1014 are rotatable around the movable part 1020. A state in which the first flap 1012 and the second flap 1014 rest on each other will be referred to as a closed state of the mobile appliance 1010, and a state in which they do not rest on each other will be referred to as an opened state of the mobile appliance 1010. The mobile appliance 1010 may assume a closed state or an opened state by allowing the first flap 1012 and the second flap 1014 to slide past each other. In this case, the movable part 1020 constitutes a sliding mechanism.

The first flap 1012 is provided with a display unit 1018 for displaying information such as characters and images, and a speaker 1024. A heat radiation plate 1016 of a circuit device 1030 described later is provided so as to be exposed at the surface of the first flap 1012. The second flap 1014 is provided with an operational unit 1022 such as buttons, and a microphone unit 1026. The closed state is a state in which the operational unit 1022 cannot be used. The opened state is a state in which the operational unit 1022 can be used.

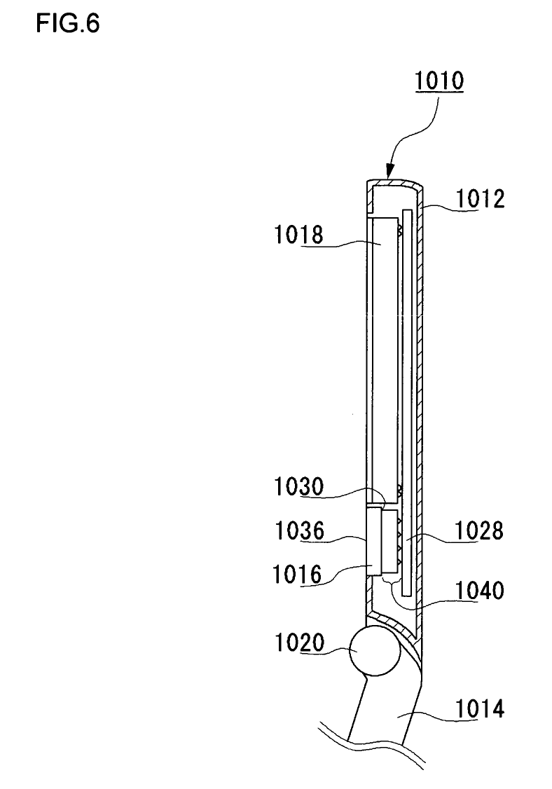

FIG. 6 is a sectional view showing the mobile appliance according to the second embodiment in an opened state. For convenience, the section of only the first flap 1012 is shown. The display unit 1018 and the circuit device 1030 are electrically connected to each other via a printed board 1028. The display unit may comprise a liquid crystal display (LCD) and may be provided with a backlight.

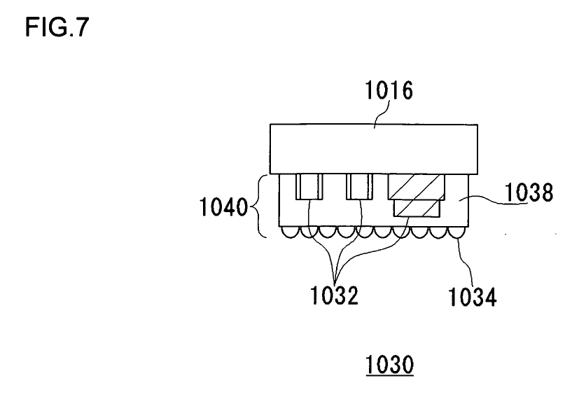

FIG. 7 is a sectional view showing the structure of the circuit device according to the second embodiment. The circuit device 1030 integrally comprises the heat radiation plate 1016 and a circuit unit 1040 formed thereon. The circuit unit 1014 is provided with circuit elements 1032, an insulating layer 1038 covering the circuit elements 1032, and solders 1034. The circuit elements 1032 include active elements and passive elements. The insulating layer 1038 is provided with conductive regions electrically connecting between the circuit elements 1032 and between the circuit element 1032 and the solder 1034. The heat radiation plate 1016 may be made by a metal with excellent thermal conductivity such as copper and aluminum.

The circuit device 1030 is electrically connected with the printed board 1028 via the solders 1034 provided on a surface opposite to the heat radiation plate 1016. The circuit unit 1040 may be a semiconductor circuit for image processing such as encoding and decoding.

As shown in FIG. 6, the surface of the heat radiation plate 1016 of the circuit device 1030 that is opposite to the surface on which the circuit unit 1040 is formed is exposed outside the first flap 1012. The surface exposed outside the first flap 1012 will be referred to as an exposed surface 1036. The exposed surface 1036 of the heat radiation plate 1016 may be polished to obscure the boundary with the first flap 1012. Alternatively, surface treatment such as coating may be applied to the exposed surface 1036 of the heat radiation plate 1016 to obscure the boundary with the first flap 1012. The surface treatment may be the spray coating of the exposed surface 1036 of the heat radiation plate 1016 with acrylic resin with a coating thickness of approximately 2-15 μm.

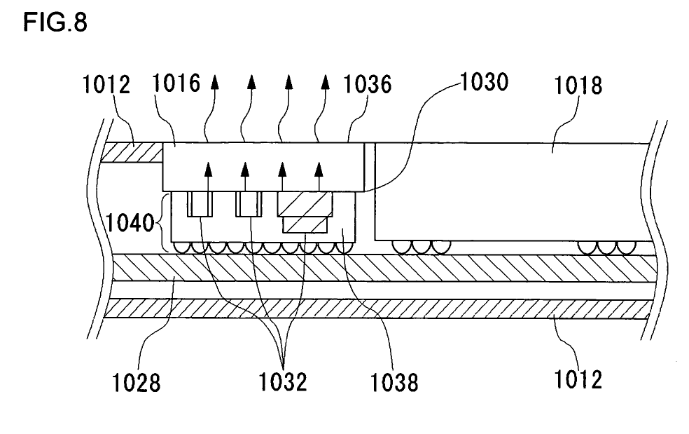

FIG. 8 shows how heat is radiated in the circuit device according to the second embodiment. In FIG. 8, arrows designate the flow of heat. Heat generated in the circuit elements 1032 is conducted to the heat radiation plate 1016 and radiated via the exposed surface 1036 of the heat radiation plate 1016.

Since the exposed surface 1036 of the heat radiation plate 1016 is exposed outside the first flap 1012, heat is prevented from being contained inside the first flap 1012 and is radiated outside the first flap 1012 efficiently. Direct thermal coupling between the circuit unit 1040 and the heat radiation plate 1016 ensures better heat radiation efficiency than when an extension is provided, and is effective for miniaturization of the electronic appliance 1010.

Since heat is radiated as described above, an increase in temperature around the circuit device 1030 is suppressed. Even if the amount of heat generated by the circuit elements 1032 is large, other electronic components are allowed to be arranged in the neighborhood of the circuit device 1030.

The heat radiation plate 1016 may be provided in the neighborhood of the display unit 1018. If the circuit unit 1040 is a semiconductor circuit for image processing, the heat radiation plate 1016 may be provided in the neighborhood of the display unit 1018. This will reduce the length of wirings and enable high-speed and high-definition display of moving images.

The heat radiation plate 1016 may be provided in the neighborhood of the movable part 1020. In this case, even if the face is pressed against the mobile appliance 1010 while communication is proceeding, a space is created due to the movable part 1020 between the exposed surface 1036 and the face, thereby preventing heat from being felt by a user.

In recent years, a mobile terminal is more and more often used to download music or image information. A semiconductor circuit is generating heat while download is proceeding. Therefore, to address the mode of use as described above, it is preferable that a heat radiation unit be provided outside an area brought into contact with the user's body from the perspective of preventing low-temperature burn.

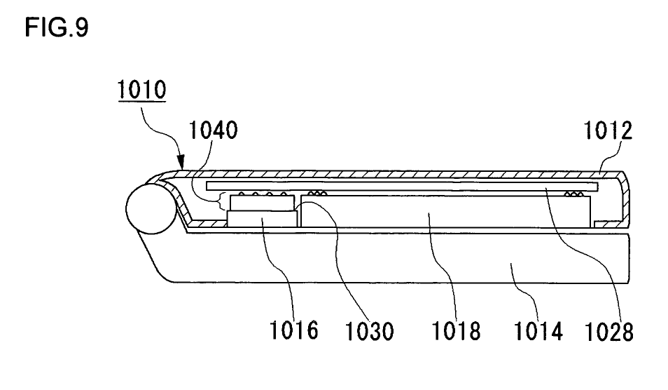

FIG. 9 is a sectional view showing the mobile appliance according to the second embodiment in an opened state. For convenience, the section of only the first flap 1012 is shown. When the circuit elements 1032 are driven in a state in which the mobile appliance 1010 is closed, heat generated in the circuit elements 1032 is conducted to the heat radiation plate 1016 and radiated outside the first flap 1012.

As shown in FIG. 9, in a state in which the mobile appliance 1010 is closed, the exposed surface 1036 of the heat radiation plate 1016 is covered by the second flap 1014 and is not brought into contact with the user's body. Even if the circuit elements 1032 are driven while the mobile appliance 1010 is being placed in a pocket of the clothes, there is no worry that low-temperature burn is caused.

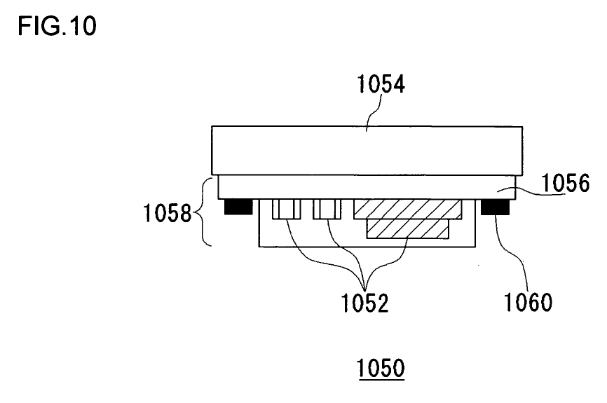

FIG. 10 is a sectional view showing the circuit device according to a variation of the second embodiment. The circuit device 1050 integrally comprises a heat radiation plate 1054 and a circuit unit 1058 formed thereon. The circuit unit 1058 is provided with an insulating layer 1056, circuit elements 1052 and an electrode 1060. The circuit elements 1052 include active elements and passive elements. The insulating layer 1056 is provided with conductive regions electrically connecting between the circuit elements 1052 and between the circuit element 1052 and the electrode 1060.

A material in which heat conductive filler is used as an additive may be used to form the insulating layer 1056 in order to increase the heat radiation efficiency of the circuit element 1052. The heat radiation plate 1054 may be made by a metal with excellent thermal conductivity such as copper and aluminum. The circuit device 1050 is electrically connected to a printed board via the electrode 1060.

Even when the circuit device 1030 of the electronic appliance 1010 shown in FIG. 6 is replaced by the circuit device 1050 shown in FIG. 10, heat generated in the circuit elements 1052 is conducted to the heat radiation plate 1054 via the insulating

### Third Embodiment

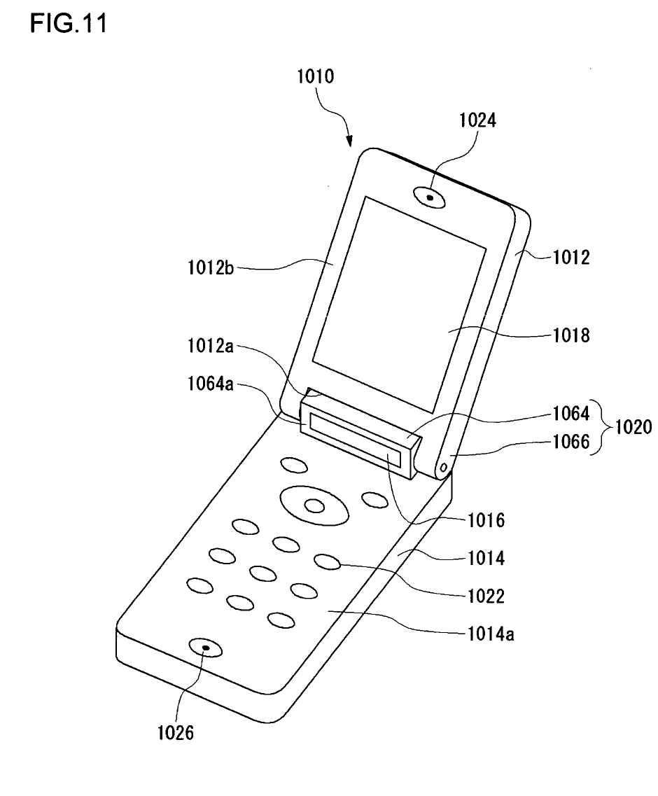

FIG. 11 shows the structure of a mobile appliance according to a third embodiment of the present invention. As shown in FIG. 11, a mobile appliance 1010 according to the third embodiment is a so-called flip mobile appliance in which the first flap 1012 and the second flap 1014 are connected to each other via the hinged movable part 1020, the first flap 1012 being provided with the display unit 1018 and the speaker unit 1024, and the second flap 1014 being provided with the operational unit 1022 and the microphone unit 1026. The first flap 1012 and the second flap 1014 are rotatable around the movable part 1020. The first flap 1012 and the second flap 1014 are allowed to pivot about the movable part 1020 so as to be folded. A state in which the first flap 1012 and the second flap 1014 rest on each other will be referred to as a closed state of the mobile appliance 1010, and a state in which they do not rest on each other will be referred to as an opened state of the mobile appliance 1010.

The hinged movable part 1020 is provided with a projecting part 1064 and a hinge support piece 1066. The projecting part 1064 has a form of a square pole and projects from an end of a microphone unit surface 1014a, which is provided with the operational unit 1022 and the microphone unit 1026, in a direction perpendicular to the microphone unit surface 1014a. The projecting part 1064 is formed as an integral part of the second flap 1014. The hinge support piece 1066 projects from a lower end face 1012a of the first flap 1012 in a longitudinal direction of the first flap 1012 and are positioned so as to sandwich the sides of the projecting part 1064. The hinge support piece 1066 is formed as an integral part of the first flap 1012 and constitutes the movable part by being rotatably engaged with the projecting part 1064. The thickness of the projecting part 1064 in a direction perpendicular to the microphone unit surface 1014a is practically identical with the thickness of the first flap 1012. In a closed state of the mobile appliance 1010, a side 1064a of the projecting part 1064 facing the operational unit 1022 is covered by the lower end face 1012a of the first flap 1012.

The projecting part 1064 may be provided such that the side 1064a thereof forms a predetermined angle of inclination with respect to the microphone unit surface 1014a. Further, the projecting part 1064 may be formed such that the side 1064a thereof is practically parallel with the speaker surface 1012b of the first flap 1012 in an opened state of the mobile appliance 1010. In this case, the lower end face 1012a of the first flap 1012 is formed so as to be engaged with the inclined side 1064a of the projecting part 1064. In a closed state of the mobile appliance 1010, the side 1064a of the projecting part 1064 is covered by the lower end face 1012a of the first flap 1012.

The mobile appliance 1010 according to the third embodiment is characterized in that heat radiation plate 1016 is exposed at the side 1064a of the projecting part 1064 facing the operational unit 1022.

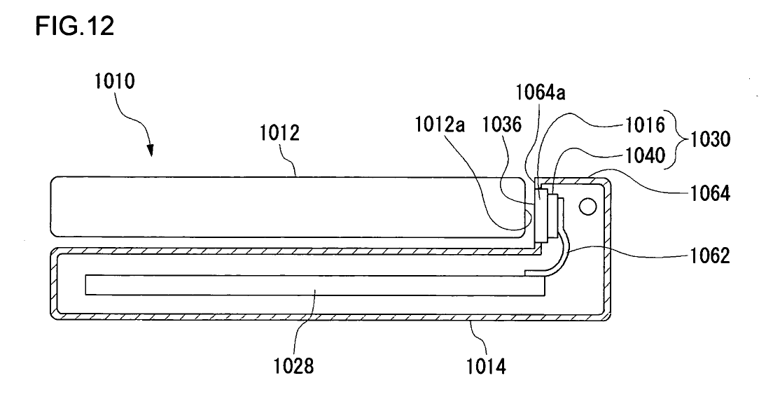

FIG. 12 is a sectional view of the mobile appliance according to the third embodiment in a closed state. For convenience, FIG. 12 only show the section of the first flap 1014. As shown in FIG. 12, the circuit device 1030 is provided inside the projecting part 1064. The structure of the circuit device 1030 may be identical with the circuit device shown in FIG. 7 or FIG. 10. The circuit device 1030 is electrically connected to the printed board 1028 via a flexible cable 1062.

The surface of the heat radiation plate 1016 of the circuit device 1030 that is opposite to the surface on which the circuit unit 1040 is formed is exposed outside at the side 1064a of the projecting part 1064. The surface of the heat radiation plate 1016 exposed outside will be referred to as the exposed surface 1036. Surface treatment may be applied to the exposed surface 1036 as in the second embodiment.

Since the heat radiation plate 1016 of the mobile appliance 1010 according to the third embodiment is exposed outside at the side 1064a of the projecting part 1064, heat is prevented from being contained inside the second flap 1014. Heat generated in the circuit unit 1040 is efficiently radiated. Since the circuit device 1030 is provided at a position spaced apart from the printed board 1028, effects upon other electronic components mounted on the printed board 1028 are reduced even if the amount of heat generated by the circuit device 1030 is large.

In the closed state of the mobile appliance 1010, the exposed surface 1036 of the heat radiation plate 1016 is covered by the lower end face 1012a of the first flap 1012 and is not brought into direct contact with the user's body. Thereby, the possibility of low-temperature burn is reduced.

### Fourth Embodiment

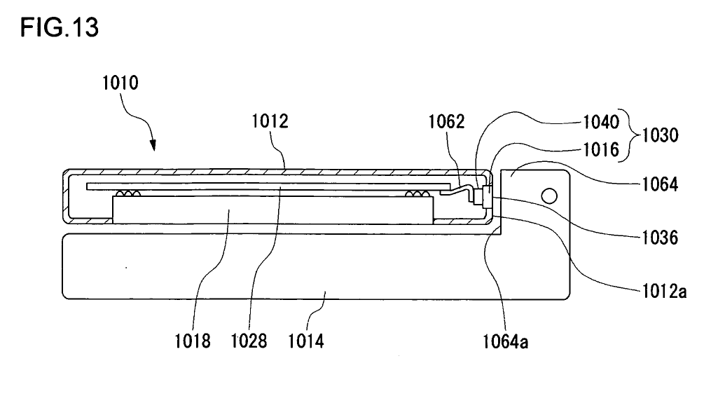

FIG. 13 is a sectional view of a mobile appliance according to a fourth embodiment of the present invention. The mobile appliance 1010 shown in FIG. 13 is a flip mobile appliance as shown in FIG. 11. FIG. 13 shows the mobile appliance 1010 in a closed state. For convenience, FIG. 13 only shows the section of the first flap 1012.

As shown in FIG. 13, the mobile appliance 1010 according to the fourth embodiment differs from the mobile appliance according to the third embodiment in that the circuit device 1030 is provided such that the heat radiation plate 1016 is exposed at the lower end face 1012a of the first flap 1012.

In the mobile appliance 1010 according to the fourth embodiment, the heat radiation plate 1016 is exposed at the lower end face 1012a of the first flap 1012. Therefore, heat is prevented from being contained inside the first flap 1012. Heat generated in the circuit unit 1040 is efficiently radiated. Since the circuit device 1030 is provided at a position spaced apart from the printed board 1028, effects upon other electronic components mounted on the printed board 1028, such as the display unit 1018, are reduced even if the amount of heat generated by the circuit device 1030 is large.

In the closed state of the mobile appliance 1010, the exposed surface 1036 of the heat radiation plate 1016 is covered by the side 1064a of the projecting part 1064 and is not brought into direct contact with the user's body. Thereby, the possibility of low-temperature burn is reduced.

### Fifth Embodiment

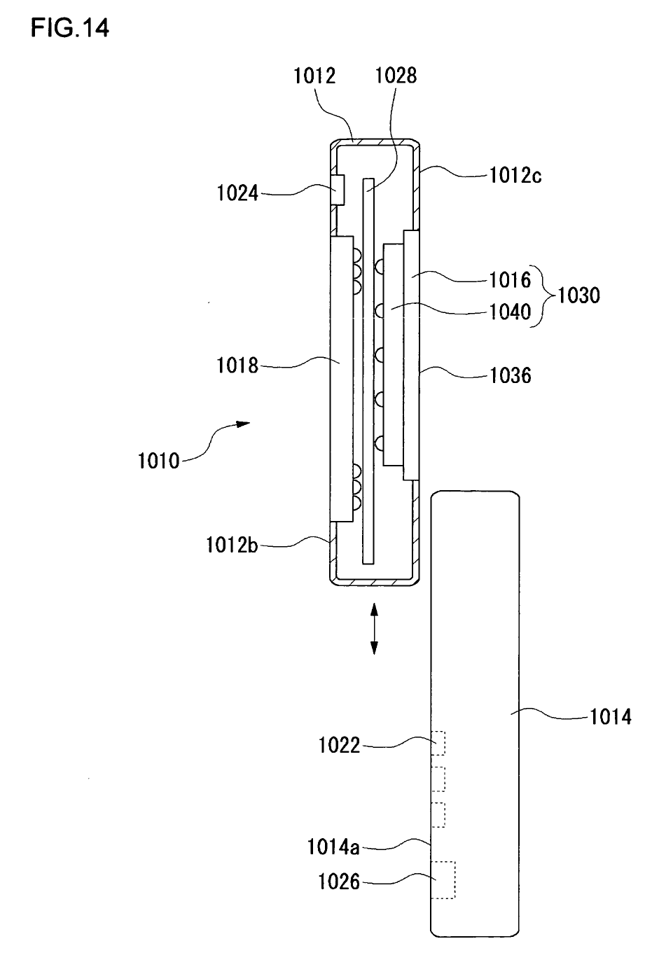

FIG. 14 is a sectional view of a mobile appliance according to a fifth embodiment of the present invention. For convenience, FIG. 14 only shows the section of the first flap 1012. As shown in FIG. 14, the mobile appliance 1010 according to the fifth embodiment is a slider mobile appliance in which the first flap 1012 and the second flap 1014 are connected to each other via a slidably movable part (not shown), the first flap 1012 being provided with the display unit 1018 and the speaker unit 1024, and the second flap 1014 being provided with the operational unit 1022 and the microphone unit 1026. The first flap 1012 and the second flap 1014 can slide past each other in practically parallel directions. A state in which the first flap 1012 and the second flap 1014 rest on each other and in which a speaker unit back surface 1012c of the first flap 1012, opposite to a speaker unit surface 1012b provided with the speaker unit 1024, is covered by the microphone unit surface 1014a of the second flap 1014 provided with the microphone unit 1026, will be referred to as a closed state of the mobile appliance 1010. A state in which the first flap 1012 and the second flap 1014 do not rest on each other will be referred to as an opened state of the mobile appliance 1010. FIG. 14 shows the mobile appliance 1010 in an opened state.

In the mobile appliance 1010 according to the fifth embodiment, the circuit device 1030 is provided such that the heat radiation plate 1016 is exposed at the speaker unit back surface 1012c. The structure of the circuit device 1030 may be identical with the circuit device shown in FIG. 7 or FIG. 10. The circuit device 1030 is electrically connected to electronic components such as the display unit 1018 via the printed board 1028. The surface of the heat radiation plate 1016 exposed outside will be referred to as the exposed surface 1036. Surface treatment may be applied to the exposed surface 1036 as in the second embodiment.

Since the heat radiation plate 1016 of the mobile appliance 1010 according to the fifth embodiment is exposed outside first flap 1012, heat is prevented from being contained inside the first flap 1012. Heat generated in the circuit unit 1040 is efficiently radiated. As heat is radiated as described above, an increase in temperature around the circuit device 1030 is suppressed. Therefore, even if the amount of heat generated by the circuit device 1030 is large, electronic components such as the display unit 1080 are allowed to be arranged in the neighborhood of the circuit device 1030 so that the size of the electronic appliance 1010 is effectively reduced.

In the closed state of the mobile appliance 1010, the exposed surface 1036 of the heat radiation plate 1016 is covered by the microphone unit surface 1014a of the second flap 1014 so that the heat radiation plate 1016 is not brought into direct contact with the user's body. Thereby, the possibility of low-temperature burn is reduced.

In the mobile appliance 1010 according to the fifth embodiment, the heat radiation plate 1016 is exposed at the speaker unit back surface 1012c opposite to the speaker unit surface 1012b provided with the speaker unit 1024. Therefore, even if the face is pressed against the mobile appliance 1010 while communication is proceeding, heat is prevented from being felt by a user.

### Sixth Embodiment

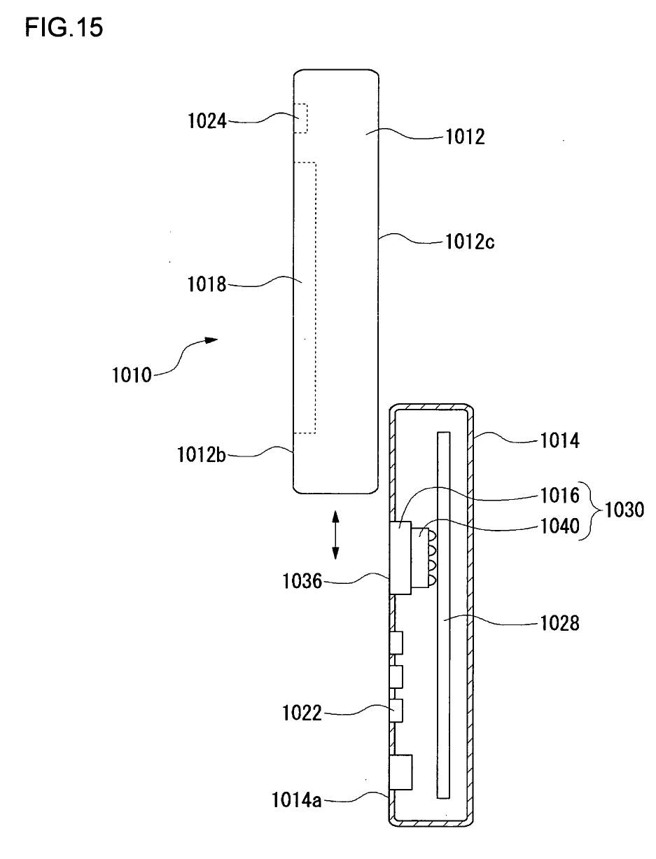

FIG. 15 is a sectional view of a mobile appliance according to a sixth embodiment of the present invention. For convenience, FIG. 15 only shows the section of the second flap 1014. Similarly to the mobile appliance according to the fifth embodiment shown in FIG. 14, the mobile appliance 1010 according to the sixth embodiment is also a slider mobile appliance. As shown in FIG. 15, a difference from the mobile appliance according to the fifth embodiment is that the circuit device 1030 of the mobile appliance 1010 according to the sixth embodiment is provided such that the heat radiation plate 1016 is exposed at the microphone unit surface 1014a of the second flap 1014.

Since the heat radiation plate 1016 of the mobile appliance 1010 according to the sixth embodiment is exposed outside second flap 1014, heat is prevented from being contained inside the second flap 1014. Heat generated in the circuit unit 1040 is efficiently radiated. As heat is radiated as described above, an increase in temperature around the circuit device 1030 is suppressed. Therefore, even if the amount of heat generated by the circuit device 1030 is large, other electronic components are allowed to be arranged in the neighborhood of the circuit device 1030 so that the size of the electronic appliance 1010 is effectively reduced.

In the closed state of the mobile appliance 1010, the exposed surface 1036 of the heat radiation plate 1016 is covered by the speaker unit back surface 1012c of the first flap 1012 so that the heat radiation plate 1016 is not brought into direct contact with the user's body. Thereby, the possibility of low-temperature burn is reduced.

In the mobile appliance 1010 according to the sixth embodiment, a space is created due to the thickness of the first flap 1012 between the exposed surface 1036 of the heat radiation plate 1016 and the face, even if the face is pressed against the mobile appliance 1010. Thereby heat is prevented from being felt by a user.

### Seventh Embodiment

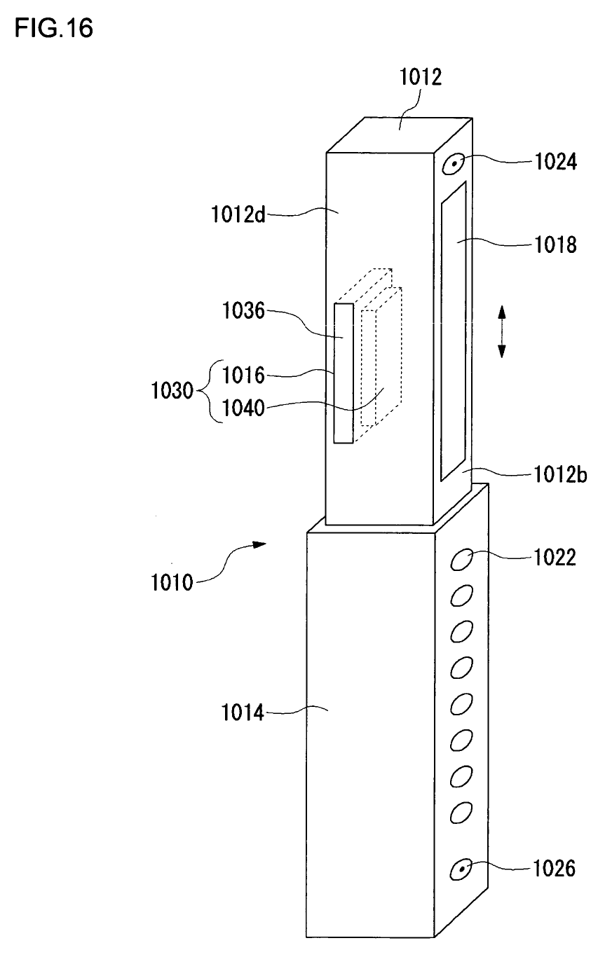

FIG. 16 shows a mobile appliance according to a seventh embodiment of the present invention. In FIG. 16, some components inside the flap are depicted by broken lines. As shown in FIG. 16, the mobile appliance 1010 according to the seventh embodiment is a stick appliance in which the first flap 1012 is accommodated in the second flap 1014, the first flap 1012 being provided with the speaker unit 1024 and the display unit 1018, and the second flap 1014 being provided with the operational unit 1022 and the microphone unit 1026. The first flap 1012 and the second flap 1014 are connected to each other via a slidably movable part (not shown) so that the first flap 1012 and the second flap 1014 can slide past each other in practically parallel directions. A state in which the first flap 1012 is accommodated in the second flap 1014 will be referred to as a closed state of the mobile appliance 1010, and a state in which the it is not accommodated will be referred to as an opened state. FIG. 16 shows the mobile appliance 1010 in an opened state.

As shown in FIG. 16, the circuit device 1030 is provided in the first flap 1012 of the mobile appliance 1010. The structure of the circuit device 1030 may be identical with the circuit device shown in FIG. 7 or FIG. 10. The display unit 1018 and the circuit device 1030 are electrically connected to each other via a printed board (not shown).

The circuit device 1030 is provided such that the side of the heat radiation plate 1016, contiguous with the surface on which the circuit unit 1040 is formed, is exposed outside at a side 1012d of the first flap 1012 contiguous with the speaker unit surface 1012b. The surface of the heat radiation plate 1016 exposed outside the first flap 1012 will be referred to as the exposed surface 1036. Surface treatment may be applied to the exposed surface 1036 as in the second embodiment. While FIG. 16 shows the heat radiation plate 1016 exposed at the side 1012d of the first flap 1012, the heat radiation plate 1016 may be exposed at both sides thereof. Alternatively, the heat radiation plate 1016 may be exposed at the speaker unit back surface 1012c of the first flap 1012.

Since the heat radiation plate 1016 of the mobile appliance 1010 according to the seventh embodiment is exposed outside the first flap 1012, heat is prevented from being contained inside the first flap 1012. Heat generated in the circuit unit 1040 is efficiently radiated. As heat is radiated as described above, an increase in temperature around the circuit device 1030 is suppressed. Therefore, even if the amount of heat generated by the circuit device 1030 is large, other electronic components are allowed to be arranged in the neighborhood of the circuit device 1030 so that the size of the electronic appliance 1010 is effectively reduced.

In the closed state of the mobile appliance 1010, the exposed surface 1036 of the heat radiation plate 1016 is covered by the second flap 1014 so that the heat radiation plate 1016 is not brought into direct contact with the user's body. Thereby, the possibility of low-temperature burn is reduced.

While the preferred embodiments of the present invention have been described using specific terms, such description is for illustrative purposes only, and it is to be understood that changes and variations may be made without departing from the spirit or scope of the appended claims.

What is claimed is:

1. A heat radiation structure for an electronic appliance which radiates heat generated in a heat generating member inside a flap of the electronic appliance to a space outside the flap, comprising:
a heat radiation plate integrally formed with a circuit element, wherein
the heat radiation plate is thermally coupled to the heat generating member and is provided at a position exposed outside the flap.

2. The heat radiation structure for an electronic appliance according to claim 1, wherein the heat radiation plate is made by a metal.

3. The heat radiation structure for an electronic appliance according to claim 1, wherein the heat radiation plate and the heat generating member are thermally coupled via a heat conductive member.

4. The heat radiation structure for an electronic appliance according to claim 2, wherein the heat radiation plate and the heat generating member are thermally coupled via a heat conductive member.

5. The heat radiation structure for an electronic appliance according to claim 1, wherein the heat generating member is a battery unit.

6. The heat radiation structure for an electronic appliance according to claim 2, wherein the heat generating member is a battery unit.

7. The heat radiation structure for an electronic appliance according to claim 3, wherein the heat generating member is a battery unit.

8. The heat radiation structure for an electronic appliance according to claim 4, wherein the heat generating member is a battery unit.

9. A mobile appliance in which a first flap and a second flap are connected to each other via a movable part, and which assumes at least two states including a first state in which the first flap and the second flap are open and a second state in which the flaps are closed, comprising:
a heat radiation plate exposed outside the first flap, wherein
an exposed surface of the heat radiation plate is covered by the second flap in the second state.

10. The mobile appliance according to claim 9, wherein the heat radiation plate is integrally formed with a circuit element.

11. The mobile appliance according to claim 9, wherein the first flap comprises a display unit, and the heat radiation plate is provided in the neighborhood of the display unit.

12. The mobile appliance according to claim 10, wherein the first flap comprises a display unit, and the heat radiation plate is provided in the neighborhood of the display unit.

13. The mobile appliance according to claim 9, wherein the heat radiation plate is provided in the neighborhood of the movable part.

14. The mobile appliance according to claim 10, wherein the heat radiation plate is provided in the neighborhood of the movable part.

15. The mobile appliance according to claim 11, wherein the heat radiation plate is provided in the neighborhood of the movable part.

16. The mobile appliance according to claim 12, wherein the heat radiation plate is provided in the neighborhood of the movable part.

17. The mobile appliance according to claim 9, wherein the movable part is a hinged movable part, and the mobile appliance is capable of assuming at least two states including an opened state and a closed state, as a result of the first flap and the second flap being folded.

18. The mobile appliance according to claim 10, wherein the movable part is a hinged movable part, and the mobile appliance is capable of assuming at least two states including an opened state and a closed state, as a result of the first flap and the second flap being folded.

19. The mobile appliance according to claim 9, wherein the movable part is a slidably movable part, and the mobile appliance is capable of assuming at least two states including an opened state and a closed state, as a result of the first flap and the second flap sliding past each other in practically parallel directions.

20. The mobile appliance according to claim 10, wherein the movable part is a slidably movable part, and the mobile appliance is capable of assuming at least two states including an opened state and a closed state, as a result of the first flap and the second flap sliding past each other in practically parallel directions.
